(19) United States
(12) Patent Application Publication
(10) Pub. No.: US 2012/0254819 A1
(43) Pub. Date: Oct. 4, 2012

(54) CIRCUIT DIAGRAM CREATION SUPPORT METHOD AND APPARATUS

(75) Inventor: Miki TAKAGI, Kawasaki (JP)

(73) Assignee: FUJITSU LIMITED, Kawasaki-shi (JP)

(21) Appl. No.: 13/426,658

(22) Filed: Mar. 22, 2012

(30) Foreign Application Priority Data
Mar. 28, 2011 (JP) 2011-071148

(51) Int. Cl. G06F 17/50

(52) U.S. Cl. 716/126

(57) ABSTRACT

The disclosed method includes: generating data of a first circuit diagram by disposing a block that represents a connection relationship between first branch lines included in a first bus line in a second circuit diagram and second branch lines included in a second bus line to be connected to the first bus line in the second circuit diagram so as to connect the first bus line with the second bus line through the block, wherein the block represents that the connection relationship identified by connection relationship data is depicted in detail in a lower-layer than a layer of the block; and generating display data including the connection relationship data and the first circuit diagram to output the generated display data.

### CROSS-REFERENCE TO RELATED APPLICATIONS

This application is based upon and claims the benefit of priority of the prior Japanese Patent Application No. 2011-071148, filed on Mar. 28, 2011, the entire contents of which are incorporated herein by reference.

### FIELD

This technique relates to a technique for supporting creation of a circuit diagram.

### BACKGROUND

In recent years, large-scale integration of circuitry on printed circuit boards is advancing, so various methods are being devised for effectively performing the work such as sharing the design work and utilizing past assets. However, together with this, the occasions for a designer to perform the work of embedding or connecting circuits outside the range of their own responsibility are increasing, so there are cases in which errors occur and the work efficiency drops instead.

For example, as for circuits for which connections on the bus line have not been designed, it is presumed that the connecting work on the bus line is carried out. FIG. 1 is a drawing illustrating an example of a circuit, and this circuit includes: a bus line 10 that includes a branch line 0 and a branch line 1; a bus line 20 that includes a branch line A and branch line B; and a bus line 30 that includes branch lines 1 to 4. Here, it is assumed that the bus lines on the input side are the bus line 10 and bus line 20, and the bus line on the output side is the bus line 30.

In case of connecting the branch lines on the input side with the branch lines on the output side, often the branch lines with the same name are connected. However, in the example in FIG. 1, when the branch lines with the same name are simply connected, the branch line 1 on the bus line 10 and the branch line 1 on the bus line 30 can be connected, however, the other branch lines cannot be connected. When it is not possible to adequately identify a connection relationship between the branch lines as in the case of this example, it may be necessary to carry out work of understanding circuits for which the design work has been completed, or changing circuits for which the design work has been completed. Such work requires a large amount of time, and places a large burden on the designer.

Conventionally, there is a following connection technique of the bus lines. For example, there is a technique for creating circuit diagrams that can easily express various wiring relationships. More specifically, in an upper-layer circuit diagram, the same symbol names and symbol numbers are given to elements having the same configuration, and plural elements having the same configuration are collectively notated as one element. Moreover, a terminal connection table is created that makes it possible to see at a glance the connection destinations for each symbol number at specific terminals of the collectively notated elements, and that table is placed on the upper layer circuit diagram. However, this technique presumes that the connection relationship has been settled, and it is not possible to determine a connection relationship for bus lines that are not connected. Therefore, this technique does not taken into consideration eliminating the occurrence of the work of changing circuits whose design has been completed, when connecting bus lines.

Moreover, there is a technique for automatically performing the work of creating and handling CAD (Computer Aided Design) library models as much as possible. In this technique, by designating pins, the designated pins are automatically connected.

Furthermore, there is a technique for designing electrical circuits having good wiring efficiency in the design of electrical circuits for multi-layered boards and LSI (Large Scale Integration). More specifically, when performing bus wiring with a virtual bus while assuming that the plural signal lines included in a bus is handled as one signal line, the virtual bus is displayed over a wiring path, when the wiring path is inputted on a computer screen. When the wiring direction changes, the wiring is carried out while virtual via holes are automatically generated on the virtual bus, and the wiring layers are automatically changed.

However, these techniques cannot resolve the aforementioned problems.

Namely, the conventional technique cannot efficiently conduct the connection of the bus lines.

### SUMMARY

A circuit diagram creation support method according to this technique includes: generating data of a first circuit diagram by disposing a block that represents a connection relationship between first branch lines included in a first bus line in a second circuit diagram and second branch lines included in a second bus line to be connected to the first bus line in the second circuit diagram so as to connect the first bus line with the second bus line through the block, wherein the block represents that the connection relationship identified by connection relationship data is depicted in detail in a lower-layer than a layer of the block; and generating display data including the connection relationship data and the first circuit diagram to output the generated display data.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a diagram depicting an example of circuits;

FIG. 2 is a functional block diagram of a circuit diagram creation support apparatus relating to this embodiment;

FIG. 3 is a diagram depicting an example of data stored in a bus line data storage unit;

FIG. 4 is a diagram to explain a wiring order;

FIG. 5 is a diagram depicting a main processing flow;

FIG. 6 is a diagram depicting an example of data stored in a splitting data storage unit;

FIG. 7 is a diagram depicting the main processing flow;

FIG. 8 is a diagram depicting an example of circuits;

FIG. 9 is a diagram depicting an example of data stored in a connection relationship data storage unit;

FIG. 10 is a diagram depicting an example of a confirmation screen;

FIG. 11 is a diagram depicting an example of a parent-layer circuit diagram;

FIG. 12 is a diagram depicting examples of blocks and branch line correspondence tables;

FIG. 13 is a diagram depicting examples of blocks and branch line correspondence tables;

FIG. 14 is a diagram depicting examples of blocks and branch line correspondence tables:

FIG. 15 is a diagram depicting the main processing flow;

FIG. 16 is a diagram depicting an example of a child-layer circuit diagram;

FIG. 17 is a diagram depicting an example of the child-layer circuit diagram;

FIG. 18 is a diagram depicting an example of the child-layer circuit diagram;

FIG. 19 is a diagram depicting an example of the child-layer circuit diagram;

FIG. 20 is a diagram depicting an example of a grandchild-layer circuit diagram; and

FIG. 21 is a functional block diagram of a computer.

### DESCRIPTION OF EMBODIMENTS

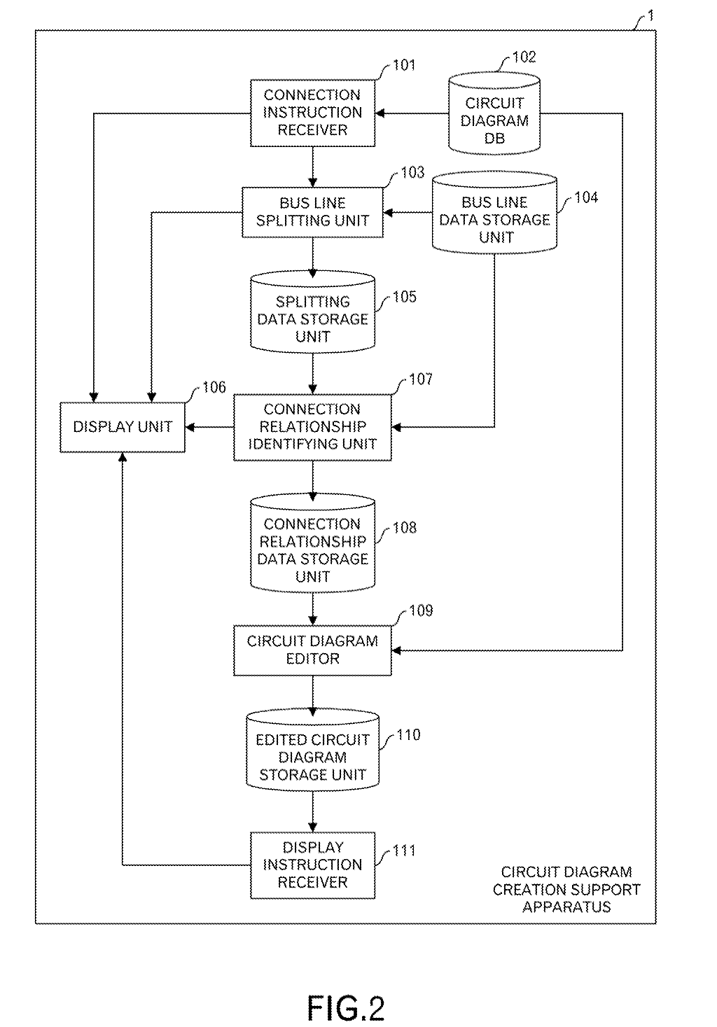

FIG. 2 illustrates a functional block diagram of a circuit diagram creation support apparatus 1 relating to an embodiment. The circuit diagram creation support apparatus 1 includes a connection instruction receiver 101, a circuit diagram database (DB) 102, a bus line splitting unit 103, a bus line data storage unit 104, a splitting data storage unit 105, a display unit 106, a connection relationship identifying unit 107, a connection relationship data storage unit 108, a circuit diagram editor 109, an edited circuit diagram storage unit 110 and a display instruction receiver 111.

The connection instruction receiver 101 reads data of a circuit diagram data, which is stored in the circuit diagram DB 102, and instructs the display unit 106 to display that circuit diagram. When an instruction is received from a user to connect bus lines, the connection instruction receiver 101 notifies the bus line splitting unit 103 of that instruction. The bus line splitting unit 103 uses data that is stored in the bus line data storage unit 104 to split bus lines in a circuit diagram into an input side and output side, and stores the splitting result data in the splitting data storage unit 105. When it is not possible to split the bus lines, the bus line splitting unit 103 instructs the display unit 106 to display a warning screen. The connection relationship identifying unit 107 uses data that is stored in the splitting data storage unit 105 and bus line data storage unit 104 to generate connection relationship data, and stores the generated data in the connection relationship data storage unit 108. The connection relationship identifying unit 107 also instructs the display unit 106 to display a screen for editing the connection relationship data. The circuit diagram editor 109 carries out a processing by using data that is stored in the circuit diagram DB 102 and connection relationship data storage unit 108, and stores the processing results in the edited circuit diagram storage unit 110. The display instruction receiver 111 instructs the display unit 106 to display the circuit diagram data that is stored in the edited circuit diagram storage unit 110. When receiving an instruction from the connection instruction receiver 101, bus line splitting unit 103, connection relationship identifying unit 107 or display instruction receiver 111, the display unit 106 displays the data relating to the instruction on a display device or the like.

FIG. 3 illustrates an example of data that is stored in the bus line data storage unit 104. In the example in FIG. 3, the bus names, branch line names and data of wiring order are stored. This kind of data is stored in the bus line data storage unit 104 for each circuit diagram stored in the circuit diagram DB 102.

The wiring order is explained in detail using FIG. 4. In the example in FIG. 4, the order of wiring the branch lines included in the bus line “_BUS_9” is illustrated. In other words, as for the bus line “_BUS_9”, first, branch line 1 is wired, next branch line 3 is wired and finally branch line 2 is wired. In this way, this means that the wiring order and branch line names do not always match.

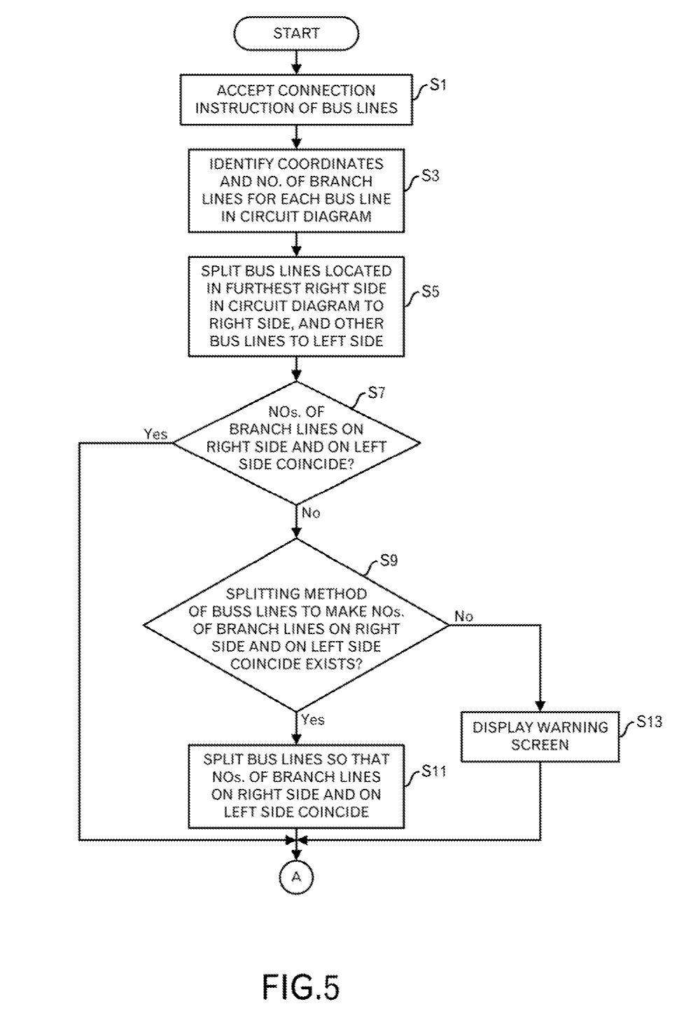

Next, the operation of the circuit diagram creation support apparatus 1 will be explained using FIG. 5 to FIG. 20. First, when the connection instruction receiver 101 of the circuit diagram creation support apparatus 1 receives an instruction from a user to display a circuit diagram, the connection instruction receiver 101 reads the data of the designated circuit diagram (hereafter, call the circuit diagram to be processed) from the circuit diagram DB 102. The connection instruction receiver 101 then causes the display unit 106 to display the data of the circuit diagram to be processed. The display unit 106 displays the data of the circuit diagram to be processed on a display device or the like in response to the instruction from the connection instruction receiver 101.

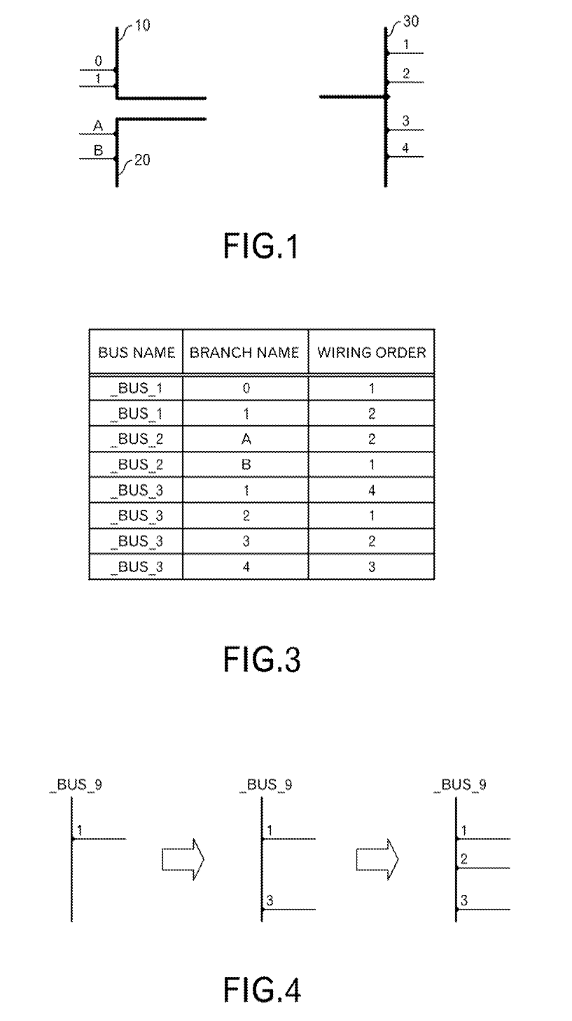

In this embodiment, the circuit diagram to be processed is the circuit diagram such as illustrated in FIG. 1. In other words, the bus line 10, bus line 20 and bus line 30 are already in place, and these bus lines are unconnected. The user checks the circuit diagram that is displayed on the display device, and decides the connection of the bus lines. Next, by operating an input device (for example a mouse or keyboard), the user gives an instruction to connect the bus lines in the circuit diagram to be processed.

On the other hand, when the connection instruction receiver 101 receives a bus line connection instruction (FIG. 3: step S1), the connection instruction receiver 101 notifies the bus line splitting unit 103 that the connection instruction was received.

The bus line splitting unit 103 then counts the number of records stored in the bus line data storage unit 104 for the bus lines in the circuit diagram to be processed to identify the number of branch lines that are included in the bus lines in the circuit diagram to be processed, and then stores the counted number in a storage device such as a main memory. The bus line splitting unit 103 also identifies the coordinates of the bus line in that circuit diagram to be processed, from the data for the circuit diagram to be processed (i.e. coordinates of the starting points of the bus lines), and stores the results in the storage device such as a main memory (step S3).

The bus line splitting unit 103 also splits the bus line that is located on the furthest right in the circuit diagram to be processed to the right side and the other bus lines to the left side, based on the coordinates of the bus lines, which are identified at the step S3, and stores the data of the splitting results in the splitting data storage unit 105 (step S5). In this embodiment, the “right side” means the output side and the “left side” means the input side.

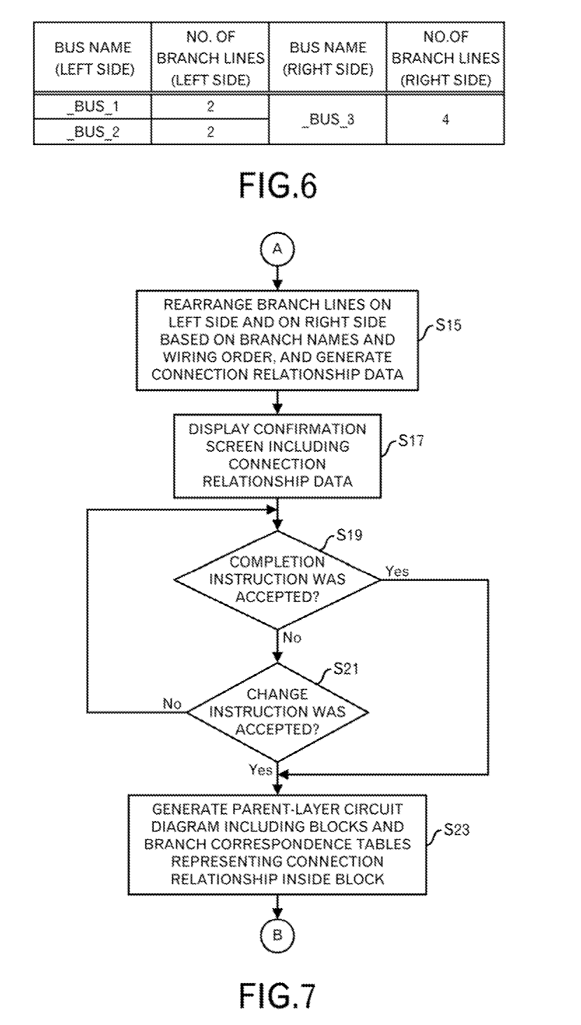

FIG. 6 illustrates an example of data that is stored in the splitting data storage unit 105. In the example in FIG. 6, the bus names of the bus lines that are split to the left side, the number of branch lines that are included in the bus lines that are split to the left side, the bus names of the bus line that is split to the right side and the number of branch lines that are included in the bus line that is split to the right side are stored.

The bus line splitting unit 103 then determines whether or not the number of branch lines included in the busses that are split to the right side is the same as the number of branch lines included in the busses that are split to the left side (step S7). In the example in FIG. 6, the numbers of branch lines on the right side and on the left side are the same. When it is determined that the numbers of branch lines on the right side and on the left side are the same (step S7: YES route), the processing moves to step S15 in FIG. 7 via terminal A.

On the other hand, when it is determined that the numbers of branch lines on the right side and on the left side are not the same (step S7: NO route), the bus line splitting unit 103 uses the data for the numbers of branch lines, which are stored the splitting data storage unit 105, to determine whether or not there is a bus line splitting method that can make the numbers of branch lines on the right side and on the left side the same (step S9). When it is determined that there is a bus line splitting method that can make the numbers of branch lines on the right side and on the left side the same (step S9: YES route), the bus line splitting unit 103 splits the bus lines again so that the numbers of branch lines on the right side and on the left side are the same, and updates the data that is stored in the splitting data storage unit 105 (step S11).

However, when it is determined that there is no splitting method that can make the numbers of branch lines on the right side and on the left side the same (step S9: NO route), the bus line splitting unit 103 instructs the display unit 106 to display a warning screen. The display unit 106 then displays a warning screen on the display device or the like to the effect that it was not possible to suitably split the bus lines (step S13). The processing then moves to the processing of the step S15 in FIG. 7 via the terminal A.

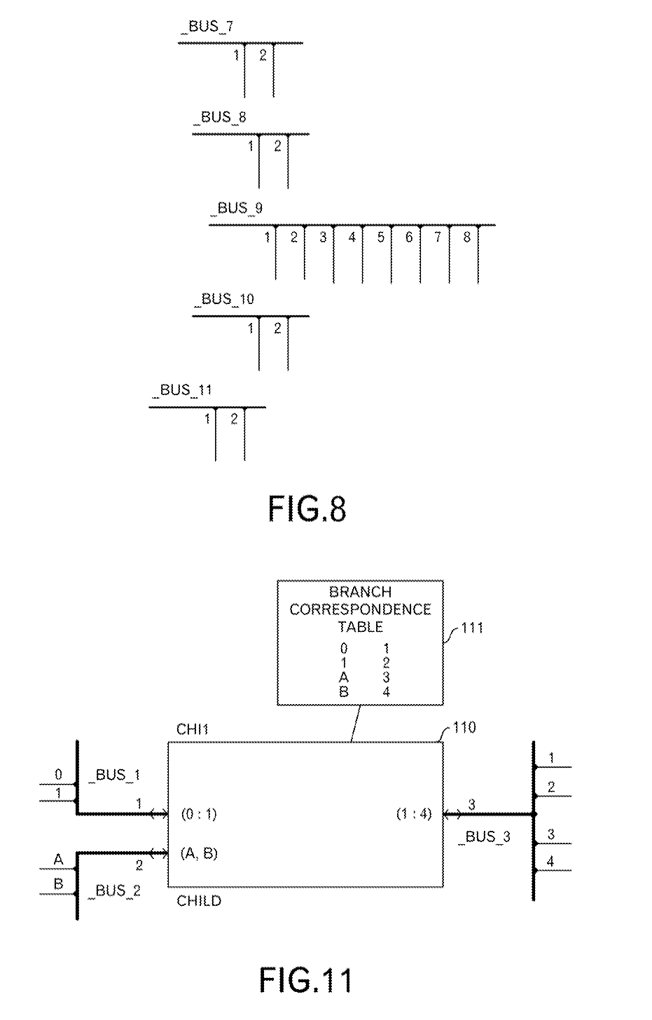

The processing from the step S5 to S11 will be explained in detail using another circuit diagram. For example, in the case of splitting bus lines in the diagram illustrated in FIG. 8, first, in the processing of the step S5, the bus line “_BUS_9” is split to the right side (output side), and the other bus lines are split to the left side (input side). At the step S7, it is determined whether or not the numbers of branch lines on the right side and on the left side are the same, and in the case of the example in FIG. 8, it is determined that the numbers are the same. Therefore, the bus line “_BUS_9” is split to the right side, and the bus lines “_BUS_7”, “_BUS_8”, “_BUS_10” and “_BUS_11” are split to the left side.

Moving on to an explanation of FIG. 7, the connection relationship identifying unit 107 rearranges (or in other words, sorts) the branch lines that are included in the bus lines on the right side and on the left side based on branch line name or wiring order data that is stored in the bus line data storage unit 104, to generate connection relationship data (step S15). The connection relationship identifying unit 107 then stores the connection relationship data in the connection relationship data storage unit 108.

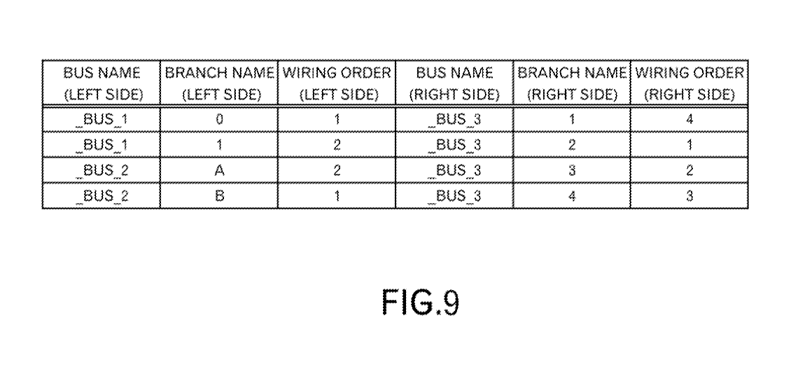

FIG. 9 illustrates an example of data that is stored in the connection relationship data storage unit 108. In the example in FIG. 9, the bus names of the busses that are split to the left, the names of the branch lines that are included in the bus lines that are split to the left, the wiring order data of the branch lines that are included in the bus lines that are split to the left, the bus name of the bus split to the right, the names of the branch lines included in the bus line that is split to the right, and the wiring order data of the branch lines that are included in the bus line that is split to the right are included. For example, the data on the first line in FIG. 9 represents that branch line 0 that is included in bus line “_BUS_1”, and branch line 1 that is included in bus line “_BUS_3” are connected. In the example in FIG. 9, the data is rearranged according to the branch line name.

The connection relationship identifying unit 107 then instructs the display unit 106 to display a confirmation screen that includes the connection relationship data. The display unit 106 displays a confirmation screen that includes the connection relationship data, on the display device or the like (step S17).

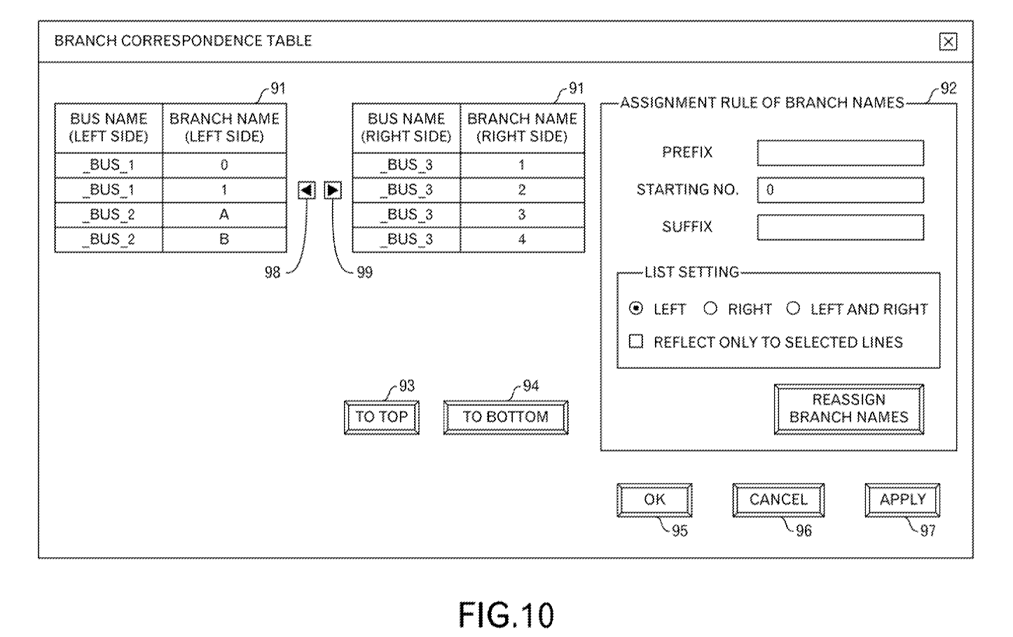

FIG. 10 illustrates an example of the confirmation screen. In the example in FIG. 10, the confirmation screen includes: a correspondence table 91 that expresses the connection relationships of the branch lines; an area 92 for assigning branch line names; buttons 93 and 94 for editing the connection relationships; buttons 95 to 97 for notifying the connection relationship identifying unit 107 that the connection relationships have been confirmed, and for closing the confirmation screen; and buttons 98 and 99 for moving the branch line from the right side to the left side or from the left side to the right side. When changing the connection relationship, the user, for example, selects the branch line name of the branch line to be changed. Then, by pressing the buttons 93 or 94, the user moves the data of the branch line to the top or bottom of the screen. Also, by pressing the buttons 98 or 99, the user moves the branch line between the right side and left side. After the connection relationships have been settled, the user presses the buttons 95 or 97 to send a completion instruction or change instruction to the connection relationship identifying unit 107. When a connection relationship is changed with the operation of the button 93 or button 94, a change instruction is outputted, and when not changed, a completion instruction is outputted.

As a result, even when the connection relationship that is identified by the circuit diagram creation support apparatus 1 is not suitable, the user can carries out suitable corrections.

The connection relationship identifying unit 107 then determines whether or not a completion instruction was received (step S19). When a completion instruction was received (step S19: YES route), the connection relationship is settled, so the processing moves to the processing of step S23. On the other hand, when a completion instruction has not been received (step S19: NO route), the connection relationship identifying unit 107 determines whether or not a change instruction was received (step S21). When it is determined that a change instruction has not been received (step S21: NO route), the processing returns to the processing of the step S19 in order to wait for an instruction from the user.

On the other hand, when it is determined that a change instruction was received (step S21: YES route), the connection relationship identifying unit 107 generates connection relationship data again according to the change instruction, and updates the connection relationship data storage unit 108 with the generated data.

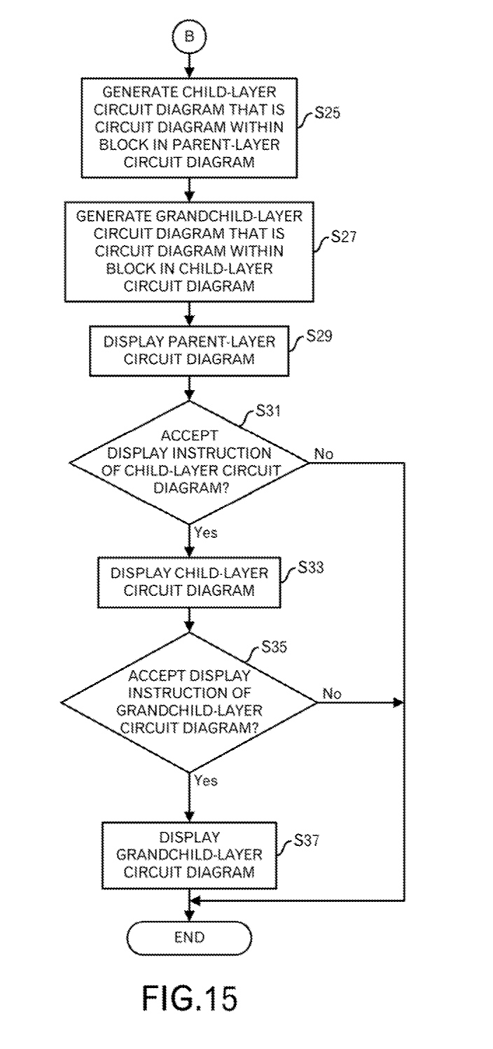

The circuit diagram editor 109 then reads the data for the circuit diagram to be processed, which is stored in the circuit diagram DB 102, edits data of the circuit diagram to be processed so that a block is placed at the connecting portion of the bus lines and so that a branch line correspondence table is added to that block, and generates data for a parent-layer circuit diagram (step S23). The circuit diagram editor 109 also stores the data for the parent-layer circuit diagram in the edited circuit diagram storage unit 110. The processing then moves to step S25 in FIG. 15 via terminal B.

FIG. 11 illustrates an example of the parent-layer circuit diagram that was generated at the step S23. In the example in FIG. 11, the bus lines (“_BUS_1” and “_BUS_2”) on the input side and the bus line (“_BUS_3”) on the output side are connected via a block 110. The block 110 includes information about the branch lines that are included in the bus lines, which are connected to the block 110. However, this information does not include information that represents the connection relationships between the branch lines on the input side and the branch lines on the output side. Incidentally, the text “CHILD” that is attached to the block 110 represents that a detailed circuit diagram of that block is given in a lower layer (in other words, a child layer).

Moreover, a branch line correspondence table 111 is attached to the block 110. The branch line correspondence table 111 simply expresses the connection relationships between the branch lines on the input side and the branch lines on the output side. In the example in FIG. 11, the table represents that branch line 0 on the input side is connected to branch line 1 on the output side, that branch line 1 on the input side is connected to branch line 2 on the output side, that branch line A on the input side is connected to branch line 3 on the output side, and that branch line B on the input side is connected to branch line 4 on the output side. Even though the detailed diagram inside the block is not displayed on the parent-layer circuit diagram, the user can confirm the connection relationships by looking at the branch line correspondence table 111.

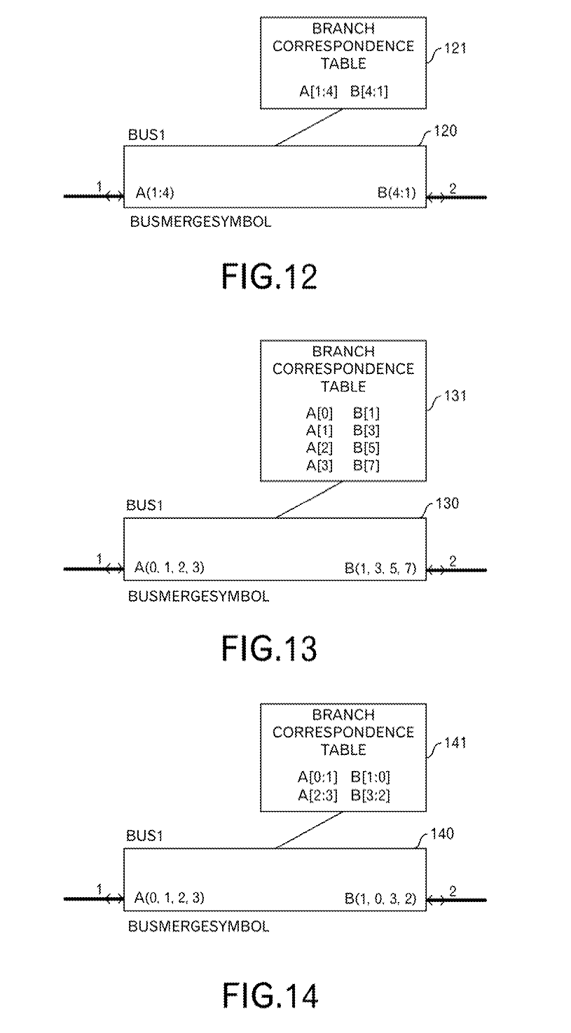

FIG. 12 to FIG. 14 illustrate other examples of blocks and branch line correspondence tables. First, in the example in FIG. 12, a branch line correspondence table 121 is attached to the block 120. In the example in FIG. 12, the numbers of the branch lines on the left side are arranged as “1, 2, 3, 4”, however, the numbers of the branch lines on the right side are arranged as “4, 3, 2, 1”, so the contents of the branch line correspondence table are organized.

In the example in FIG. 13, the branch line correspondence table 131 is attached to the block 130. In the example in FIG. 13, the numbers of the branch lines on the left side are arranged as “0, 1, 2, 3”, however, the numbers of the branch lines on the right side are arranged as “1, 3, 5, 7”. Therefore, it is not possible to organize the branch line correspondence table as in the example in FIG. 12, so the contents are displayed in detail.

In the example in FIG. 14, the branch line correspondence table 141 is attached to the block 140. In the example in FIG. 14, the numbers of the branch lines on the left side are arranged as “0, 1, 2, 3”, and the numbers of the branch lines on the right side are arranged as “1, 0, 3, 2”. Therefore, only portions of the branch line correspondence table are organized.

Moving to an explanation of FIG. 15, the circuit diagram editor 109 generates data for the child-layer circuit diagram, which is the circuit diagram inside the block on the parent-layer circuit diagram, and stores the generated data in the edited circuit diagram storage unit 110 (step S25).

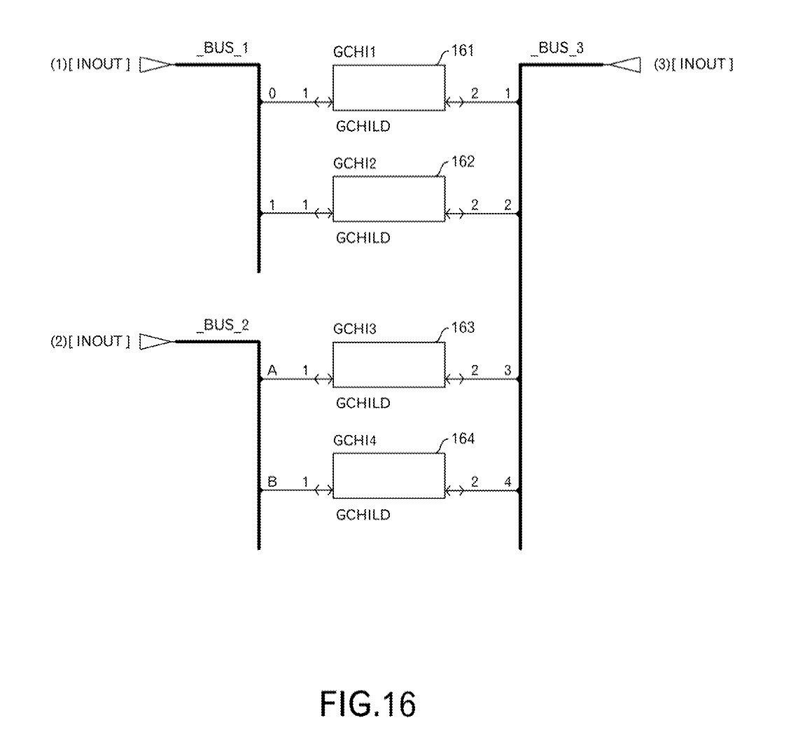

FIG. 16 illustrates an example of a child-layer circuit diagram that is generated at the step S25. In the example in FIG. 16, the connection relationship between the bus lines on the input side (“_BUS_1” and “_BUS_2”) and the bus lines on the output side (“_BUS_3”) is given in detail in the child-layer circuit diagram. However, blocks 161 to 164 with the text “GCHILD” are arranged in the connection section between branch lines, and the details of the connection relationships in the block are displayed as a grandchild-layer circuit diagram.

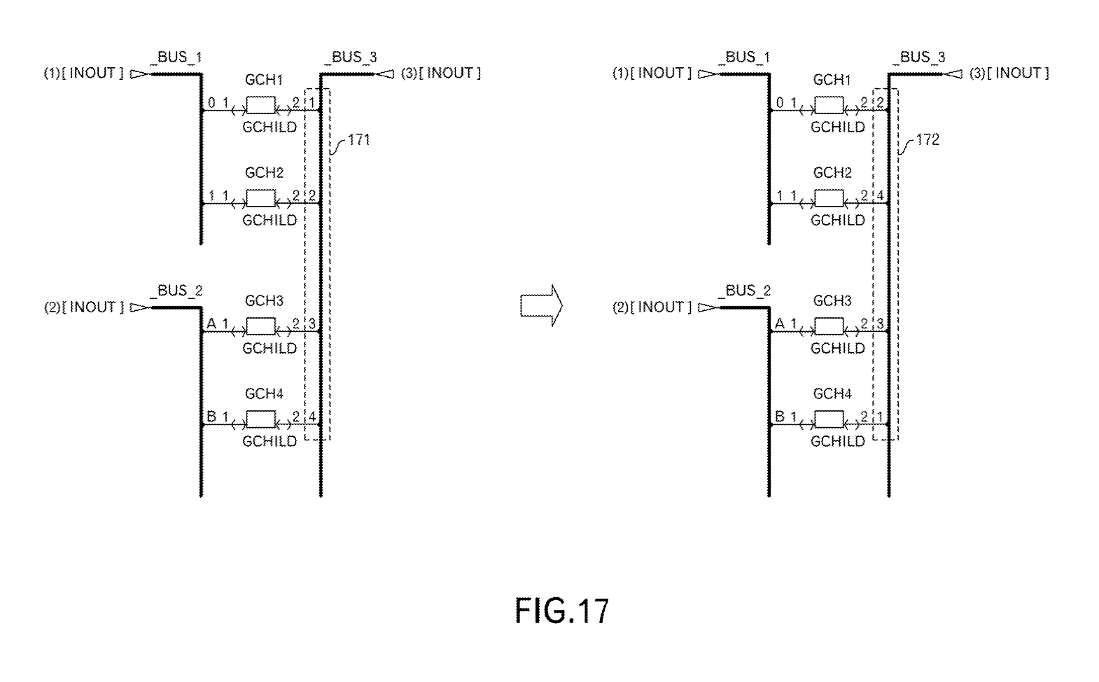

FIG. 17 to FIG. 19 illustrate other examples of child-layer circuit diagrams. FIG. 17 is a drawing illustrating an example in the case of changing the arrangement of the branch lines on the output side, where here, it is desired to change the arrangement of the branch lines on the output side from “1, 2, 3, 4” to “2, 4, 3, 1”. In case of such a change, the portion 171 that is inside the dotted line has to be changed such as in 172. In other words, the change of only the names of the branch lines has to be carried out and any change is not required to the form of the circuits in the circuit diagram.

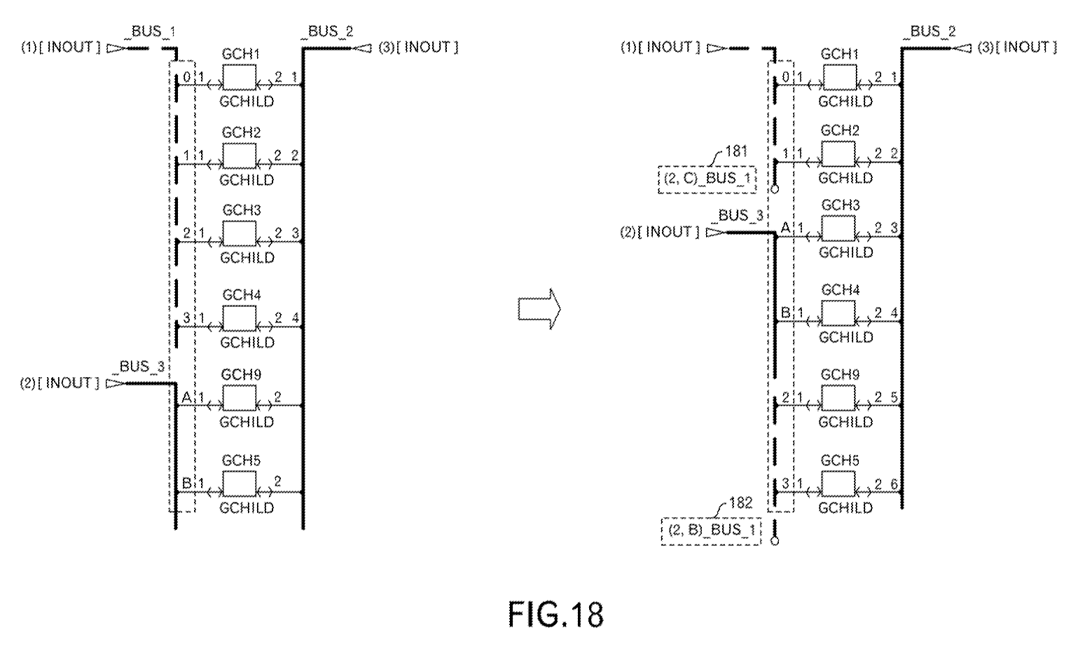

FIG. 18 is a drawing that illustrates an example of the case of changing the arrangement of the branch lines on the input side, where here, it is desired to change the arrangement of the branch lines on the input side from “0, 1, 2, 3, A, B” to “0, 1, A, B, 2, 3”. However, differing from the example in FIG. 17, there are two bus lines on the input side, so it is not possible to simply change the drawing so that the names of the branch lines are changed. Therefore, in the case of the example in FIG. 17, it is possible to change the connection relationships by splitting the bus “_BUS_1”. Here, by attaching identifiers 181 and 182 that represent to which portion the split bus lines are to be connected, it is possible to understand that the plural split sub-bus lines were originally one bus line.

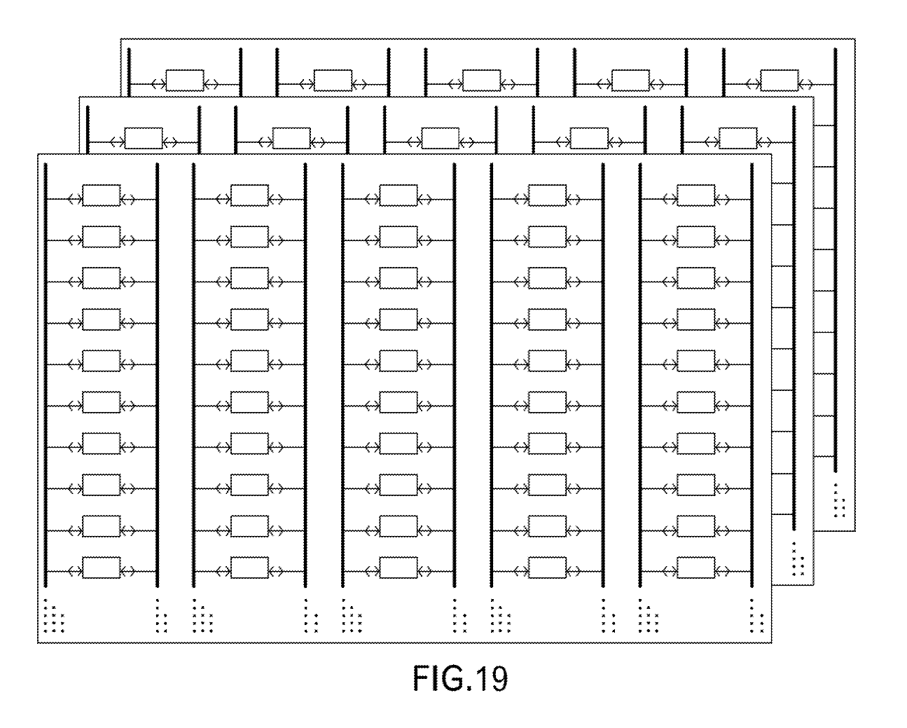

FIG. 19 is a drawing that illustrates an example of a case where there are an extremely large number of branch lines to be connected in a child-layer circuit diagram. The portions in FIG. 19 represented by dots correspond to the identifiers explained in FIG. 18. Even when there are an extremely large number of branch lines to be connected in this way, it is possible to generate a circuit diagram that is easy for the user to understand, by splitting and arranging the bus lines.

Returning to the explanation of FIG. 15, the circuit diagram editor 109 generates data for grandchild-layer circuit diagrams, which are circuit diagrams in the blocks on a child-layer circuit diagram, and stores the generated data in the edited circuit diagram storage unit 110 (step S27).

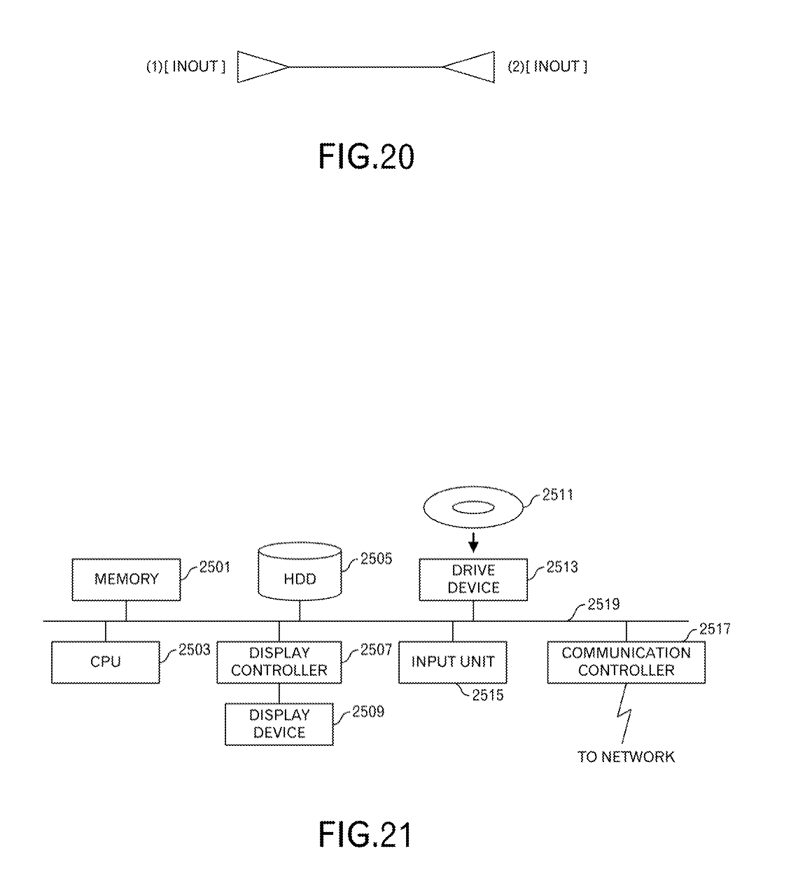

FIG. 20 illustrates an example of a grandchild-layer circuit diagram that is generated at the step S27. In the example in FIG. 20, the connection section between the branch line on the input side and the branch line on the output side is illustrated in detail.

The display instruction receiver 111 then reads the data of the parent-layer circuit diagram from the edited circuit diagram storage unit 110, and causes the display unit 106 to display the read data. In response to an instruction from the display instruction receiver 111, the display unit 106 displays the data of the parent-layer circuit diagram on the display device or the like (step S29). As a result, the user can check changed portions (in other words, the block portions) in the circuit diagram to be processed, and can check connection relationships of the branch lines in the block by the branch line correspondence table.

The display instruction receiver 111 then determines whether or not a display instruction for a child-layer circuit diagram was received (step S31). For example, when a user uses a mouse or the like and selects a block that is located on a parent-layer circuit diagram, a display instruction for the child-layer circuit diagram is outputted. When it is determined that the display instruction for the child-layer circuit diagram has not been received (step S31: NO route), the processing ends.

On the other hand, when it is determined that a display instruction for the child-layer circuit diagram was received (step S31: YES route), the display instruction receiver 111 reads data for the child-layer circuit diagram from the edited circuit diagram storage unit 110, and causes the display unit 106 to display the read data. The display unit 106 displays the data for the child-layer circuit diagram on the display device or the like (step S33). As a result, the user is able to check the details of the connection relationships between the branch lines in the block.

The display instruction receiver 111 then determines whether or not a display instruction for a grandchild-layer circuit diagram has been received (step S35). For example, when a user uses a mouse or the like to select a block that is located on the child-layer circuit diagram, a display instruction of the grandchild-layer circuit diagram is outputted. When it is determined that the display instruction for the grandchild-layer circuit diagram has not been received (step S35: NO route), the processing ends.

However, when it is determined that the display instruction for the grandchild-layer circuit diagram has been received (step S35: YES route), the display instruction receiver 111 reads data for the grandchild-layer circuit diagram from the edited circuit diagram storage unit 110, and causes the display unit 106 to display the read data. The display unit 106 displays the data for the grandchild-layer circuit diagram on the display device or the like (step S37). The processing then ends. As a result, the user is able to further check the detailed contents of the connection portions.

By carrying out the aforementioned processing, the bus lines that are not connected are connected. By doing so, only connection portions of the bus lines (in other words, the portions where a block is placed) are changed without changing the portions for which the design is already completed. Consequently, a user does not need to deeply understand portions for which the design is already completed, and does not need to change portions for which the design is already completed. Therefore, the burden of work on a user is reduced, and the work efficiency is improved.

Although one embodiment of this technique was explained, this technique is not limited to this embodiment. For example, the functional block diagram of the aforementioned circuit diagram creation support apparatus 1 does not always correspond to an actual program module configuration.

In addition, configurations of the respective table described above are mere examples, and the aforementioned configurations may be changed. Furthermore, as for the processing flows, the order of the steps may be exchanged as long as the processing results do not change. Moreover, the steps may be executed in parallel as long as the processing results do not change.

Incidentally, after identifying the connection relationship by the processing from the steps S3 to S15 in the aforementioned example, the results are displayed to the user. However, a processing may be carried out to simply list data of the bus lines to be connected on the confirmation screen in FIG. 10 and to cause the user to determine the connection relationship from the first step.

In addition, the aforementioned circuit diagram creation support apparatus 1 is a computer device as shown in FIG. 21. That is, a memory 2501 (storage device), a CPU 2503 (processor), a hard disk drive (HDD) 2505, a display controller 2507 connected to a display device 2509, a drive device 2513 for a removable disk 2511, an input device 2515, and a communication controller 2517 for connection with a network are connected through a bus 2519 as shown in FIG. 21. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform necessary operations. Besides, intermediate processing data is stored in the memory 2501, and if necessary, it is stored in the HDD 2505. In this embodiment of this technique, the application program to realize the aforementioned functions is stored in the computer-readable, non-transitory removable disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the necessary application programs systematically cooperate with each other, so that various functions as described above in details are realized.

Incidentally, the respective processing units depicted in FIG. 2 may be realized by a combination of the CPU 2503 and programs, in other words, by the CPU 2503 executing the programs. More specifically, the CPU 2503 operates according to the programs stored in the HDD 2505 or memory 2501 to function as the aforementioned processing units. In addition, the respective data storage units illustrated in FIG. 2 may be implemented as the memory 2501, HDD 2505 or the like in FIG. 21.

The aforementioned embodiment of this technique is summarized as follows:

A circuit diagram creation support method according to the embodiment includes: (A) generating data of a first circuit diagram by disposing a block that represents a connection relationship between first branch lines included in a first bus line in a second circuit diagram and second branch lines included in a second bus line to be connected to the first bus line in the second circuit diagram so as to connect the first bus line with the second bus line through the block, wherein the block represents that the connection relationship identified by connection relationship data stored in a storage device is depicted in detail in a lower-layer than a layer of the block; and (B) generating display data including the connection relationship data and the first circuit diagram to output the generated display data.

By doing so, it is possible to limit a portion to which change is added to a portion of the block. Therefore, there is no need to change the circuits for which the design is already complete. Thus, because there is no need to deeply understand the circuits for which the design is already complete, and carry out the change for which the design is already complete, the work efficiency is improved. In addition, as for the connection relationship within the block, it becomes possible to confirm it by using the connection relationship data.

Moreover, the aforementioned method may further include: (C) reading the connection relationship data from the storage device, and outputting the connection relationship data in a mode that a user is capable of editing the connection relationship data; and (D) in response to receipt of edited connection relationship data, updating the connection relationship data stored in the storage device by the edited connection relationship data. By enabling the user to edit the connection relationship data, it is possible to suppress inappropriate connection relationship remains.

Furthermore, the aforementioned method may further include: (E) first ordering the first branch lines according to names of the first branch lines or a temporal sequence that the first branch lines were disposed, by using first data including, for each bus line, names of branch lines included in the bus line or data of a temporal sequence that the branch lines included in the bus line were disposed, wherein the first data is stored in a bus line data storage unit; second ordering the second branch lines according to names of the second branch lines or a temporal sequence that the second branch lines were disposed, by using the first data; and (F) identifying connection relationship between the first branch lines and the second branch lines by associating the first branch lines with the second branch lines based on results of the first ordering and the second ordering. In this way, it becomes possible to automatically identify the probable connection relationship.

Moreover, the aforementioned method may further include: (G) identifying, for each bus line included in the second circuit diagram, the number of branch lines included in the bus line by using the first data stored in the bus line data storage unit; and (H) splitting bus lines to be connected to the first bus line and to the second bus line so as to make the number of branch lines in an input side and the number of branch lines in an output side coincide. By doing so, it is possible to appropriately split the bus lines to be connected in the circuit diagram to the input side and to the output side.

In addition, the aforementioned method may further include: (I) generating data of a third circuit diagram that is a circuit diagram within the block by using the connection relationship data stored in the storage device; and (J) outputting the data of the third circuit diagram in response to detecting that the block in the first circuit diagram is selected. Thus, it is possible to suitably check the circuit diagram in the lower-layer, in which the details of the connection relationship are illustrated.

Furthermore, at least one bus line of bus lines included in the third circuit diagram may be split to a plurality of sub-bus lines and the plurality of sub-bus lines may be disposed in the third circuit diagram, and an identifier representing a portion to be connected to another sub-bus line among the plurality of sub-bus lines may be assigned to each of the plurality of sub-bus lines. Thus, when the bus lines can be split to plural sub-bus lines, it is possible to create the circuit diagram, flexibly.

Incidentally, it is possible to create a program causing a computer to execute the aforementioned processing, and such a program is stored in a computer readable storage medium or storage device such as a flexible disk, CD-ROM, DVD-ROM, magneto-optic disk, a semiconductor memory, and hard disk. In addition, the intermediate processing result is temporarily stored in a storage device such as a main memory or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A computer-readable, non-transitory storage medium storing a program for causing a computer to execute a procedure comprising:
generating data of a first circuit diagram by disposing a block that represents a connection relationship between first branch lines included in a first bus line in a second circuit diagram and second branch lines included in a second bus line to be connected to the first bus line in the second circuit diagram so as to connect the first bus line with the second bus line through the block, wherein the block represents that the connection relationship identified by connection relationship data is depicted in detail in a lower-layer than a layer of the block; and
generating display data including the connection relationship data and the first circuit diagram to output the generated display data.

2. The computer-readable, non-transitory storage medium as set forth in claim 1, wherein the procedure comprises:
outputting the connection relationship data in a mode that a user is capable of editing the connection relationship data; and
in response to receipt of edited connection relationship data, updating the connection relationship data by the edited connection relationship data.

3. The computer-readable, non-transitory storage medium as set forth in claim 1, wherein the procedure comprises:
first ordering the first branch lines according to names of the first branch lines or a temporal sequence that the first branch lines were disposed, by using first data including, for each bus line, names of branch lines included in the bus line or data of a temporal sequence that the branch lines included in the bus line were disposed;
second ordering the second branch lines according to names of the second branch lines or a temporal sequence that the second branch lines were disposed, by using the first data; and
identifying connection relationship between the first branch lines and the second branch lines by associating the first branch lines with the second branch lines based on results of the first ordering and the second ordering.

4. The computer-readable, non-transitory storage medium as set forth in claim 3, wherein the procedure comprises:
identifying, for each bus line included in the second circuit diagram, the number of branch lines included in the bus line by using the first data; and
splitting bus lines to be connected to the first bus line and to the second bus line so as to make the number of branch lines in an input side and the number of branch lines in an output side coincide.

5. The computer-readable, non-transitory storage medium as set forth in claim 1, wherein the procedure comprises:
generating data of a third circuit diagram that is a circuit diagram within the block by using the connection relationship data; and
outputting the data of the third circuit diagram in response to detecting that the block in the first circuit diagram is selected.

6. The computer-readable, non-transitory storage medium as set forth in claim 5, wherein at least one bus line of bus lines included in the third circuit diagram is split to a plurality of sub-bus lines and the plurality of sub-bus lines are disposed in the third circuit diagram, and an identifier representing a portion to be connected to another sub-bus line among the plurality of sub-bus lines is assigned to each of the plurality of sub-bus lines.

7. A circuit diagram creation support method comprising:
generating, by using a computer, data of a first circuit diagram by disposing a block that represents a connection relationship between first branch lines included in a first bus line in a second circuit diagram and second branch lines included in a second bus line to be connected to the first bus line in the second circuit diagram so as to connect the first bus line with the second bus line through the block, wherein the block represents that the connection relationship identified by connection relationship data is depicted in detail in a lower-layer than a layer of the block; and
generating, by using the computer, display data including the connection relationship data and the first circuit diagram to output the generated display data.

8. The circuit diagram creation support method as set forth in claim 7, further comprising:
outputting the connection relationship data in a mode that a user is capable of editing the connection relationship data; and
in response to receipt of edited connection relationship data, updating the connection relationship data by the edited connection relationship data.

9. The circuit diagram creation support method as set forth in claim 7, further comprising:
first ordering the first branch lines according to names of the first branch lines or a temporal sequence that the first branch lines were disposed, by using first data including, for each bus line, names of branch lines included in the bus line or data of a temporal sequence that the branch lines included in the bus line were disposed;
second ordering the second branch lines according to names of the second branch lines or a temporal sequence that the second branch lines were disposed, by using the first data; and
identifying connection relationship between the first branch lines and the second branch lines by associating the first branch lines with the second branch lines based on results of the first ordering and the second ordering.

10. The circuit diagram creation support method as set forth in claim 9, wherein the procedure comprises:
identifying, for each bus line included in the second circuit diagram, the number of branch lines included in the bus line by using the first data; and
splitting bus lines to be connected to the first bus line and to the second bus line so as to make the number of branch lines in an input side and the number of branch lines in an output side coincide.

11. The circuit diagram creation support method as set forth in claim 7, further comprising:
generating data of a third circuit diagram that is a circuit diagram within the block by using the connection relationship data; and
outputting the data of the third circuit diagram in response to detecting that the block in the first circuit diagram is selected.

12. The circuit diagram creation support method as set forth in claim 11, wherein at least one bus line of bus lines included in the third circuit diagram is split to a plurality of sub-bus lines and the plurality of sub-bus lines are disposed in the third circuit diagram, and an identifier representing a portion to be connected to another sub-bus line among the plurality of sub-bus lines is assigned to each of the plurality of sub-bus lines.

13. A circuit diagram creation support apparatus comprising:
a memory; and
a processor configured to execute a procedure comprising:
generating data of a first circuit diagram by disposing a block that represents a connection relationship between first branch lines included in a first bus line in a second circuit diagram and second branch lines included in a second bus line to be connected to the first bus line in the second circuit diagram so as to connect the first bus line with the second bus line through the block, wherein the block represents that the connection relationship identified by connection relationship data stored in the memory is depicted in detail in a lower-layer than a layer of the block; and
generating display data including the connection relationship data and the first circuit diagram to output the generated display data.

14. The circuit diagram creation support apparatus as set forth in claim 13, wherein the procedure comprises:
outputting the connection relationship data in a mode that a user is capable of editing the connection relationship data; and
in response to receipt of edited connection relationship data, updating the connection relationship data by the edited connection relationship data.

15. The circuit diagram creation support apparatus as set forth in claim 13, wherein the procedure comprises:
first ordering the first branch lines according to names of the first branch lines or a temporal sequence that the first branch lines were disposed, by using first data including, for each bus line, names of branch lines included in the bus line or data of a temporal sequence that the branch lines included in the bus line were disposed;
second ordering the second branch lines according to names of the second branch lines or a temporal sequence that the second branch lines were disposed, by using the first data; and
identifying connection relationship between the first branch lines and the second branch lines by associating the first branch lines with the second branch lines based on results of the first ordering and the second ordering.

16. The circuit diagram creation support method as set forth in claim 15, wherein the procedure comprises:
identifying, for each bus line included in the second circuit diagram, the number of branch lines included in the bus line by using the first data; and
splitting bus lines to be connected to the first bus line and to the second bus line so as to make the number of branch lines in an input side and the number of branch lines in an output side coincide.

17. The circuit diagram creation support method as set forth in claim 13, wherein the procedure comprises:
generating data of a third circuit diagram that is a circuit diagram within the block by using the connection relationship data; and
outputting the data of the third circuit diagram in response to detecting that the block in the first circuit diagram is selected.

18. The circuit diagram creation support method as set forth in claim 17, wherein at least one bus line of bus lines included in the third circuit diagram is split to a plurality of sub-bus lines and the plurality of sub-bus lines are disposed in the third circuit diagram, and an identifier representing a portion to be connected to another sub-bus line among the plurality of sub-bus lines is assigned to each of the plurality of sub-bus lines.
